(19) United States
(12) Patent Application Publication
(10) Pub. No.: US 2015/0257094 A1
(43) Pub. Date: Sep. 10, 2015

(54) LOW POWER COMMUNICATION IN CONNECTED MODE

(71) Applicants: Na WEI, Beijing (CN); Wei BAI, Beijing (CN); Jing HAN, Beijing (CN); Haiming WANG, Beijing (CN); Chunyan GAO, Beijing (CN)

(72) Inventors: Na Wei, Beijing (CN); Wei Bai, Beijing (CN); Jing Han, Beijing (CN); Haiming Wang, Beijing (CN); Chunyan Gao, Beijing (CN)

(21) Appl. No.: 14/436,439

(22) PCT Filed: Oct. 17, 2012
(86) PCT No.: PCT/CN2012/083067

§ 371 Date: Apr. 16, 2015

(51) Int. Cl. H04W 52/02; H04W 24/10

(52) U.S. Cl. CPC H04W 52/02; H04W 24/10; H04W 88/08

(57) ABSTRACT

It is provided a method, comprising: signaling, to a terminal device, to turn into a low power connected mode; inhibiting signaling, to the terminal device, to turn into an idle mode; saving a parameter used to connect to the terminal device in a normal connected mode different from the low power connected mode before signaling to turn into the low power connected mode.

### FIELD OF THE INVENTION

The present invention relates to an apparatus, a method, and a computer program product for a low power connected mode. More particularly, the present invention relates to an apparatus, a method, and a computer program product for machine type communication with low power consumption in connected mode.

### BACKGROUND OF THE INVENTION

### Abbreviations

CC Component Carrier

CA Carrier Aggregation

PUCCH Physical Uplink Control Channel

PDSCH Physical Downlink Shared Channel

DRX Discontinuous Reception

DCI Downlink Control Information

DL Downlink

eNB Enhanced Node B.

LTE™ Long Term Evolution

LTE-A™ Long Term Evolution Advanced

UE User Equipment

UL Uplink

FFT Fast Fourier Transformation

MTC Machine Type Communications

PRB Physical Resource Block

3GPP 3rd Generation Partnership Project

GSM Global System for Mobile Communications

GPRS General Packet Radio Service

EPS Evolved Packet System

RAN Radio Access Network

RAT Radio Access Technology

RRC Radio Resource Control

RACH Random Access Channel

PCH Paging Channel

HRPD High Rate Packet Data

EVDO Evolution Data Only

AN Access Network

AT Access Terminal

MAC Medium Access Control

ID Identifier

IE Information Element

CQI Channel Quality Indicator

DCH Dedicated Channel

WCDMA Wideband CDMA

CDMA Code Division Multiple Access

OAM Operation & Maintenance

FACH Forward Access Channel

RRM Radio Resource Management

RLM Radio Link Management

MCS Modulation and Coding Scheme

LPCM Low Power Connected Mode

PUCCH Physical Uplink Control Channel

SR Scheduling Request

CE Control Element

C-RNTI Cell Radio Network Temporary Identifier

PDCP Packet Data Convergence Protocol

IP Internet Protocol

TMSI Temporary Mobile Subscriber Identity

TS Technical Specification

TX Transmit

RX Receive

HLR Home Location Register

HSS Home Subscriber Server

As LTE deployments evolve, operators would like to reduce the cost of overall network maintenance by minimising the number of RATS. Machine-Type Communications (MTC) is a market that is likely to continue expanding in the future. Many MTC devices are targeting low-end (low cost, low data rate) applications that can be handled adequately by GSM/GPRS. Owing to the low cost of these devices and good coverage of GSM/GPRS, there is very little motivation for MTC device suppliers to use modules supporting the LTE radio interface. As more and more MTC devices are deployed in the field, this naturally increases the reliance on GSM/GPRS networks. This will cost operators not only in terms of maintaining multiple RATs, but also prevent operators to reap the maximum benefit out of their spectrum (given the non-optimal spectrum efficiency of GSM/GPRS). Given the likely high number of MTC devices, the overall resource they will need for service provision may be correspondingly significant, and inefficiently assigned. Therefore, it is necessary to find a solution to ensure that there is a clear business benefit to MTC device vendors and operators for migrating low-end MTC devices from GSM/GPRS to LTE networks. In [1], it is suggested that solutions using, or evolved from, LTE RAN specifications up to and including Rel-10 shall be investigated and evaluated to clearly understand the feasibility of creating a type of terminal that would permit the cost of terminals tailored for the low-end of the MTC market to be competitive with that of GSM/GPRS terminals targeting the same low-end MTC market. This is an ongoing study item in 3GPP RAN1.

The high number of MTC devices might bring some potential issues, for example high RACH overload and high RRC signaling overhead [3GPP R2-116167-HW]. Besides, there is a desire for some MTC devices to be more power efficient since many are battery powered and hence, power consumption should be optimized for MTC devices.

Important properties for MTC are low payload and very infrequent transmission. Many of them are delay tolerant, too, that is, some delay for date transmission or reception does not harm. So it is likely that an MTC UE goes to RRC_connected when it needs to transmit/receive, and then gets back to RRC_idle afterwards, as shown in FIG. 1.

According to FIG. 1, the UE such as the MTC device in the RRC-Idle mode 1 monitors the PCH according to the DRX cycle. In the RRC_Connected mode 2, the MTC UE is connected to a cell. It may be out of synchronization or in synchronization. In both cases, DL reception is possible, but UL transmission is only possible if the MTC UE is in synchronization. Transitions are possible between RRC_Idle and RRC_Connected states and between the synchronization states.

This change of operational modes needs to perform quite some RRC signaling each time. Considering the large number of MTC devices, this will be a heavy load for the network, and wastes quite some power on those signaling each time.

Currently, the RRC messages for this mode change may include:
RRC connection establishment messages: (RRCConnectionRequest, RRCConnectionSetup, RRCConnectionSetupComplete),
initial security activation messages (SecurityModeCommand, SecurityModeComplete),
Radio bearer establishment messages (RRCReconfigurationRequest, RRCReconfigurationComplete),
RRC release message, handover messages (measurement report, handover command and handover complete) and RRC connection re-establishment messages (RRCConnectionReestablishmentRequest, RRCConnectionReestablishment, RRCConnectionReestablishmentComplete) according to [R2-115931—Nokia and Nokia Siemens Networks]

In some other systems, there are some modes or channels known that may help reduce power consumption.

For example, there is a Semi-connected state defined in HRPD Rev C. (1xEVDO). When entering Semi-Connected State, AN and AT agree upon monitoring intervals and durations between monitoring intervals. The AT's MAC-ID continues to be valid, and AN schedules data for AT only in monitoring intervals, and AT sends keep-alive CQIs between monitoring intervals at a reduced rate [2].

Another example is WCDMA's FACH mode. The Forward Access Channel (FACH) is a downlink transport channel that carries control information to terminals known to be located in the given cell. This is used, for example, after a random access message has been received by the base station. It is also possible to transmit packet data on the FACH. There may be more than one FACH in a cell. One of the FACHs must have such a low bit rate that it can be received by all the terminals in the cell area. With more than one FACH, the additional channels can have a higher data rate. The FACH does not use fast power control, and the messages transmitted need to include in-band identification information to ensure their correct receipt [3]. The FACH is a downlink channel with low rate payload, and MTC is to have a low rate payload in UL.

FIG. 2 shows the different RRC service states in the RRC_connected mode 2, the transitions between the service states and to/from the RRC_idle mode 1. In the RRC connected mode 2, there are the service states URA_PCH 2a, Cell_PCH 2b, Cell_FACH 2c, and Cell_DCH 2d. Transition into the RRC_idle mode may happen from each of these service states if an inactivity timer has elapsed or the RNC load is too high. Transistion back from the RRC_idle mode to the RRC_connected mode goes always into the Cell_FACH service state upon activity detection.

US 2011/269447 A1 defines a static or low mobility category, and for such UE it reduces the frequency of doing some actions, such as reducing control signaling TX/RX; reducing the frequency for monitoring the system information and the paging channel by the mobile terminal, for measurements (e.g. reception quality measurements), for measurement reporting, and for transmission of periodic tracking area update messages; and reducing the amount of measurements and the amount of reported values for each measurement reporting.

US 2012/202508 A1 discloses that a MTC UE notifies the eNB of being static.

[4] and [5] disclose independent measurement configuration.

[1] 3GPP RP-111112, “Provision of low-cost MTC UEs based on LTE”, Vodafone

[2] “Semi-Connected State”, Motorola, 2006-09, Xi'an 3GPP2. http://ftp.3gpp2.org/TSGC/working/2006/2006-09-Xian/TSG-C-2006-09/WG2/SWG22/Conf call contributions/C22 20060815/C22-20060815-023 Motorola C20-20060815-023-Semi-Connected-State.pdf

[3] “WCDMA for UMTS—HSPA Evolution and LTE”, John Wiley & Sons, 2007, 4^{th} edition, edited by Harri Holma and Antti Toskala

[4] 3GPP RP-020382, “Clarification of Measurement Validity and Valid Measurement Objects”, Motorola

[5] Joona Vehanen: “Handover between LTE and 3G Radio Access Technologies: Test measurement challenges and field environment test planning”, School of Electrical Engineering, Master's thesis, Espoo, Finland, 30.5.2011.

### SUMMARY OF THE INVENTION

It is an object of the present invention to improve the prior art.

In particular, it is an object to enable MTC devices to stay more efficiently in the network (for example low power consumption, less signaling). And among the MTC devices, the focus is on static MTC devices and/or on delay tolerant MTC devices, such as meters [1], whose static and/or delay tolerant property is not efficiently utilized yet.

Neither DRX nor FACH alone can achieve sufficient power saving for static MTC UEs. It is an object to design a mode which can enable static MTC devices to have power consumption in a level similar to idle mode or even less, therefore other power consuming functions should also be considered to be disabled, such as measurements which consume a lot of energy even in DRX mode.

Furthermore, it is an object of the invention to design a mode where signaling may be reduced using the delay tolerance of some UEs, for example. Saving signaling should be accompanied by a corresponding energy saving.

According to a first aspect of the invention, there is provided an apparatus, comprising at least one processor, at least one memory including computer program code, and the at least one processor, with the at least one memory and the computer program code, being arranged to cause the apparatus to at least perform: turning the apparatus into a low power connected mode upon receiving of a corresponding signaling from a base station device; inhibiting releasing of a cell radio network temporary identifier if the apparatus is in the low power connected mode; saving a parameter used to connect to the base station device in a normal connected mode different from the low power connected mode before turning into the low power connected mode.

According to a second aspect of the invention, there is provided an apparatus, comprising turning means adapted to turn the apparatus into a low power connected mode upon receiving of a corresponding signaling from a base station device; inhibiting means adapted to inhibit releasing of a cell radio network temporary identifier if the apparatus is in the low power connected mode; saving means adapted to save a parameter used to connect to the base station device in a normal connected mode different from the low power connected mode before turning into the low power connected mode.

According to a third aspect of the invention, there is provided an apparatus, comprising at least one processor, at least one memory including computer program code, and the at least one processor, with the at least one memory and the computer program code, being arranged to cause the apparatus to at least perform: evaluating if a received signaling indicates a linkage of a scheduling request resource and a paging occurrence such that all occurrences of the scheduling request resource are injectively mapped to occurrences of the paging occasion; reserving, if the evaluation is affirmative, the scheduling request resource according to the linkage.

According to a fourth aspect of the invention, there is provided an apparatus, comprising evaluating means adapted to evaluate if a received signaling indicates a linkage of a scheduling request resource and a paging occurrence such that all occurrences of the scheduling request resource are injectively mapped to occurrences of the paging occasion; reserving means adapted to reserve, if the evaluation is affirmative, the scheduling request resource according to the linkage.

An apparatus according to any of the first to fourth aspects may comprise a user equipment.

According to a fifth aspect of the invention, there is provided an apparatus, comprising at least one processor, at least one memory including computer program code, and the at least one processor, with the at least one memory and the computer program code, being arranged to cause the apparatus to at least perform: signaling, to a terminal device, to turn into a low power connected mode; inhibiting signaling, to the terminal device, to turn into an idle mode; saving a parameter used to connect to the terminal device in a normal connected mode different from the low power connected mode before signaling to turn into the low power connected mode.

According to a sixth aspect of the invention, there is provided an apparatus, comprising signaling means adapted to signal, to a terminal device, to turn into a low power connected mode; inhibiting means adapted to inhibit signaling, to the terminal device, to turn into an idle mode; saving means adapted to save a parameter used to connect to the terminal device in a normal connected mode different from the Low power connected mode before signaling to turn into the low power connected mode.

According to a seventh aspect of the invention, there is provided an apparatus, comprising at least one processor, at least one memory including computer program code, and the at least one processor, with the at least one memory and the computer program code, being arranged to cause the apparatus to at least perform: signaling, to a terminal device, to reserve a scheduling request resource such that all occurrences of the scheduling request resource are injectively mapped to occurrences of a paging occasion, reserving, after the signaling, the scheduling request resource for the terminal.

According to an eighth aspect of the invention, there is provided an apparatus, comprising signaling means adapted to signal, to a terminal device, to reserve a scheduling request resource such that all occurrences of the scheduling request resource are injectively mapped to occurrences of a paging occasion, reserving means adapted to reserve, after the signaling, the scheduling request resource for the terminal.

An apparatus according to any of the fifth to eighth aspects may comprise a base station, a NodeB, or an eNodeB.

According to a ninth aspect of the invention, there is provided a method, comprising: turning an apparatus performing the method into a low power connected mode upon receiving of a corresponding signaling from a base station device; inhibiting releasing of a cell radio network temporary identifier if the apparatus is in the low power connected mode; saving a parameter used to connect to the base station device in a normal connected mode different from the low power connected mode before turning into the low power connected mode.

According to a tenth aspect of the invention, there is provided a method, comprising: evaluating if a received signaling indicates a linkage of a scheduling request resource and a paging occurrence such that all occurrences of the scheduling request resource are injectively mapped to occurrences of the paging occasion; reserving, if the evaluation is affirmative, the scheduling request resource according to the linkage.

According to an eleventh aspect of the invention, there is provided a method, comprising: signaling, to a terminal device, to turn into a low power connected mode; inhibiting signaling, to the terminal device, to turn into an idle mode; saving a parameter used to connect to the terminal device in a normal connected mode different from the low power connected mode before signaling to turn into the low power connected mode.

According to a twelfth aspect of the invention, there is provided a method, comprising: signaling, to a terminal device, to reserve a scheduling request resource such that all occurrences of the scheduling request resource are injectively mapped to occurrences of a paging occasion, reserving, after the signaling, the scheduling request resource for the terminal.

A method according to any of the ninth to twelfth aspects may be a method of low power communication.

According to a thirteenth aspect of the invention, there is provided a computer program product comprising a set of instructions which, when executed on an apparatus, is configured to cause the apparatus to carry out the method according to any one of the ninth to twelfth aspects. The computer program product may be embodied as a computer-readable medium.

According to some embodiments of the invention, for example at least the following advantages are achieved:

According to some embodiments of the invention, the power consumption of static MTC UEs may be reduced. For example, the estimated power consumption may be similar to idle mode power consumption, or maybe even less if a longer DRX cycle period is configured, and/or if a longer paging cycle is configured than in the idle mode.

According to some embodiments of the invention, the MTC UE stays in connected mode. Thus, RRC signaling exchange may be reduced which is not necessary anymore. Considering the large number of MTC device, the saving of reduced overhead can be quite high for a base station.

According to some embodiments of the invention, the time for paging (for DL traffic arrival) and time for SR (for UL traffic arrival) is made close to each other, so static and delay tolerant MTC UE can enjoy maximize “sleeping time”, for example. Considering large number of such MTC UE, it effect saving for eNB UL resource.

According to some embodiments of the invention, signaling for delay tolerant devices is reduced and corresponding energy savings may be achieved.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the some embodiments of the present invention which is to be taken in conjunction with the appended drawings, wherein

FIG. 1 shows some properties of a UE in RRC-Idle state and RRC-Connected state and transitions between the states;

FIG. 2 shows UE operational modes and RRC service states, and transitions between them;

FIG. 3 shows an apparatus according to an embodiment of the invention;

FIG. 4 shows a method according to an embodiment of the invention;

FIG. 5 shows an apparatus according to an embodiment of the invention;

FIG. 6 shows a method according to an embodiment of the invention;

FIG. 7 shows an apparatus according to an embodiment of the invention;

FIG. 8 shows a method according to an embodiment of the invention;

FIG. 9 shows an apparatus according to an embodiment of the invention; and

FIG. 10 shows a method according to an embodiment of the invention.

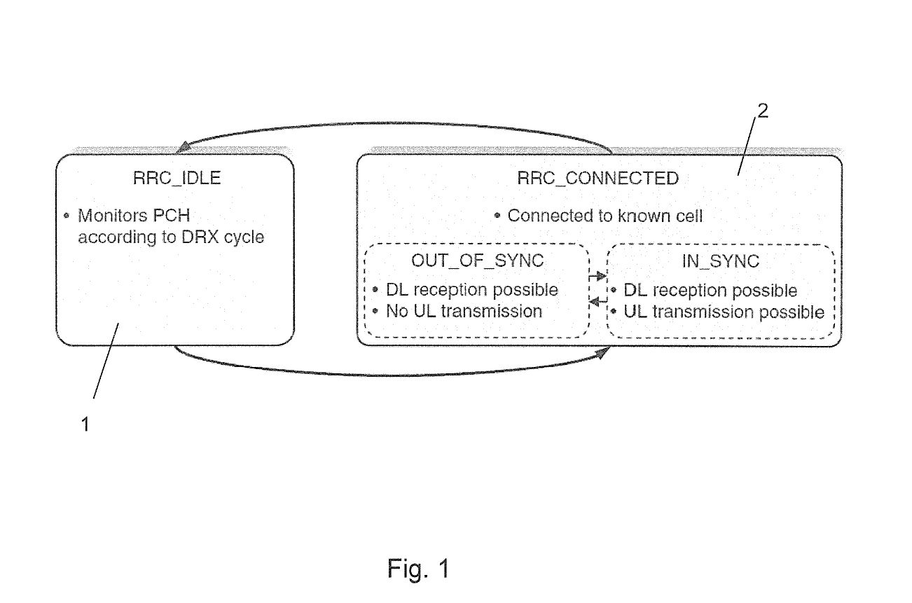

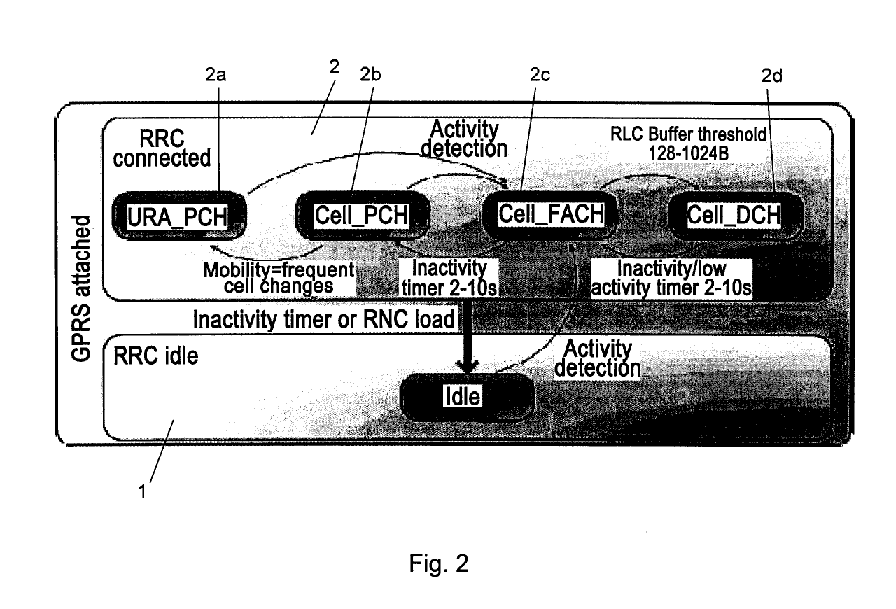

### DETAILED DESCRIPTION OF CERTAIN EMBODIMENTS

Herein below, certain embodiments of the present invention are described in detail with reference to the accompanying drawings, wherein the features of the some embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

According to some embodiments of the invention, in order to reduce static MTC power consumption and RRC signaling, the low power connected mode (LPCM) is introduced for static MTC UE. LPCM may be turned on and turned off. In addition, some further features of the MTC UE may be turned on/off when LPCM is turned on/off.

Besides, in some embodiments of the invention, MTC specific DRX parameters may be used, and/or the paging occasion may be linked to SR resource for delay tolerant MTC UE to reduce signaling and save power of MTC UE.

According to some embodiments of the invention, the MTC UE reports “static” type to the eNB. For example, this report may be included in capability IE. Alternatively, a new signaling may be used for this report. In some embodiments, the “static” property is administered in the eNB by OAM command. In some embodiments of the invention, the static property is stored in the home register (HLR or HSS) and signaled from there to the eNB.

According to some embodiments of the invention, the eNB may then use dedicated configuration signaling (e.g. RRC signaling or MAC CE) to disable/enable LPCM for a static MTC UE.

The low power connected mode (LPCM) may be predefined for static MTC UEs (e.g. meters). Once enabled in LPCM, the MTC UE will apply at least the following features unless further signaling to turn off the LPCM mode is obtained:
C-RNTI will not be released
Save/Keep at least one of
   Radio Bearer ID;
   EPS Bearer ID;
   Ciphering keys, PDCP sequence number;
   IP connection parameters; and
   TMSI.

When the MTC UE exits LPCM mode, the static MTC UE will resume the saved IDs/parameter settings/configurations as before, and perform actions accordingly.

One or more of the following optional features may or may not be configured in the LPCM mode:
Disable RRM measurement (measurement for the serving cell);
Disable RLM measurement;
Disable L1 measurement;
Disable Mobility; and
Longer SR resource period.

These features may be configured for LPCM by common RRC signaling, or they may be signaled to each MTC UE turning into LPCM mode. In some embodiments of the invention, some of these features may be signaled by common signaling, and others by dedicated signaling. Accordingly, the eNB does not expect to receive any corresponding measurement results and mobility activities from the MTC UE.

Thus, a higher flexibility of the LPCM according to specific needs is achieved.

The independent measurement enabling/disabling according to embodiments of the invention is different from that according to [4] and [5] as follows:

If a UE according to [4] or [5] needs one or more of those measurements in active transmission period, so likely such L1 measurements or RRM measurements will be configured in active period. When the UE enters sleep period, it may potentially release all the measurement objects but this will may cause big signaling overhead from time to time.

In contrast to that, according to some embodiments of the invention, the measurement object(s) may be disabled when entering into LPCM mode, and enabled when exiting LPCM mode, while the “old” setting/parameters can be kept/reused. Thus, extra RRC signaling can be saved. This applies for example for at least one of radio bearer ID, EPS bearer ID, ciphering keys, PDCP sequence number, etc.

Moreover, according to some embodiments of the invention, only certain measurement may be enabled/disables in LPCM. For example, eNB may configure RLM measurement enabled for LPCM mode (e.g. by a bitmap such as 0100, the sequence of bits in this example corresponding to the sequence of measurement types outlined hereinabove), so UE knows RLM measurement is kept while others are disabled. Another case, eNB may configure for LPCM that all measurements are disabled (e.g. by a bitmap such as 0000). Nevertheless, the old parameters are kept in UE memory. And when the UE exits this LPCM mode, UE will resume those measurement objects as configured before.

Moreover, in order to have further power saving than just disabling RRM measurements, RLM and L1 measurements may be disabled, too.

For L1 measurement, one possible way to avoid L1 measurements is to not configure any PUCCH resource for CQI reporting, however, as UE may also receive CQI request and need to report CQI in PUSCH, it may always need to do L1 measurement to be prepared. But according to some embodiments of the invention, L1 measurements may be disabled in the LPCM mode such that UE does not need to do them anymore once configured in LPCM mode.

For RLM measurement, currently RLM measurement is not configured by eNB. It is mandatory to perform RLM measurement constantly by UE (see 3GPP TS 36.213). According to some embodiments of the invention, power may be saved by disabling RLM measurements in the LPCM mode period. Considering the property of MTC UE being static, the trade off with agility is typically tolerable.

In particular for delay tolerant MTC UE, according to some embodiments of the invention, the SR resource is linked to paging occasion for an MTC UE in LPCM mode. That is, in these cases the SR resource is configured only with fixed linkage to its paging occasion. The UE may request to schedule a grant for data transmission only in the SR resource which occurs periodically with a first periodicity. eNB may page UE for data transmission only at paging occasion which occurs periodically with a second periodicity which is typically longer than the first periodicity.

More precisely, the SR resource in these embodiments is subjectively mapped to the paging occasion, which means that every occurrence of the SR resource may be mapped to one corresponding paging occasion but there may be some paging occasions which cannot be mapped to a SR resource occurrence.

Some examples of injective mapping are as follows: The SR resource linkage to paging occasion for LPCM MTC UEs can be with a fixed offset, for example n+4 subframes if n is the paging occasion subframe. Either the paging occasion may be delayed relative to the SR resource or vice versa. Also, the SR resource may occur only linked to every second, third, fourth etc. paging occasion. More generally, it may be linked to every n^{th} paging occasion with n being an integer equal to or larger than 1. The latter relation and the fixed offset may be combined.

A linkage of the SR resource and the paging occasion may also be made in UEs in RRC_connected mode if they are “delay tolerant”. For example, meters in vehicles or trains may typically not enter into the LPCM mode because they are not “static”. Nevertheless, they are typically delay tolerant. Also, some UEs used for data traffic of low budget users may be potential candidates for delay tolerance.

In this case, eNB should be informed about the delay tolerance of the UE, which may be made according to some embodiments of the invention by signaling from the UE or by OAM configuration. In some embodiments of the invention, delay tolerance is stored in the home register (HLR or HSS) and signaled from there to the eNB. eNB may inform UE about the linkage e.g. by dedicated RRC signaling or by a newly introduced signaling.

By linking SR resource and paging occasion in these UEs, signaling resources and corresponding energy may be saved. Again, if a lot of such MTC UEs are connected to an eNB, the saving may be considerable.

According to some embodiments of the invention, MTC UE may transmit some data in LPCM mode. In this case, eNB may give UL grants, for example by using fixed modulation and coding, such that MTC UE may transmit. To be on the safe side, the lowest coding scheme may be used.

Also, according to embodiments of the invention, MTC UE may go to RRC_connected mode for data transmission. The transition into the connected mode involves RRC signaling, but it requires less signaling than a transition from idle mode to connected mode since at least some of the relevant parameters are saved on both sides. In UMTS, transition may be from LPCM to Cell_DCH service state of the RRC_connected mode.

Correspondingly, MTC_UE according to some embodiments of the invention may receive data in LPCM mode when paged, or may transit into RRC-connected mode.

According to some embodiments of the invention, the eNB will maintain a list of MTC UEs with low power connected mode.

In Table 1, it is summarized whether certain activities in the RRC_connected mode are performed in idle mode and in LPCM according to some example embodiments of the invention:

TABLE 1
List of activities in RRC_connected mode, idle mode, and
LPCM according to some example embodiments of the invention.

| Activity in RRC | Activity in idle | Activity in |
|---|---|---|
| connected mode | mode | LPCM |
| Paging | Carry out | Carry out |
| Scheduling request | No. Need to re- | Carry out, e.g. |
| | establish RRC | once per paging |
| | connection first. | cycle |
| RRM Measurements | Yes, for cell | Optional/could be |
| (serving cell & | reselection | disabled |
| neighour) | purpose | |
| RLM Measurements | Yes, for cell | Optional/could be |
| | reselection | disabled |
| | purpose | |
| L1 measurements | No | Optional/could be |
| | | disabled |
| Mobility (handover) | Yes (Cell | Optional/could be |
| | selection) | disabled |
| keep of C-RNTI | Release of C-RNTI | Release of C-RNTI |
| | | inhibited |
| Data | No | Optional |
| transmission/reception | | |

In some embodiments of the invention, the following procedure is implemented:

Step 1: UE reports on static MTC type, for example, during initial access procedure e.g. in capability IE.

Step 2: Common RRC signaling informs UEs on default configurations for LPCM. For example, by common signaling, the MTC UEs are informed whether or not the optional features mentioned hereinabove are to be applied in LPCM or not.

Step 3: Dedicated signaling (e.g. dedicated RRC signaling) is used to disable/enable LPCM for a static MTC UE. In addition, by dedicated signaling, some of the optional features may be enabled or disabled. For this, e.g. a bitmap may be used.

Step 4: Once enabled, the UE will apply LPCM to save power as well as stay connected like described in above section.

SR resource is normally configured/reserved for a certain UE with certain periodicity, and this takes a lot of resource at the eNB considering MTC UE number is large and always in connected mode. More in detail, according to 3GPP TS 36.213, section 10.1.5, the SR periodicity may be between 1 ms and 80 ms. And even if a very low SR periodicity is enabled, it'll need one PUCCH resource every 80 ms [3GPP TS 36.213, section 10.1.5]. However, if SR were totally disabled the MTC UE would not have the chance to let eNB know of UL traffic arrival. Moreover, UE (even if totally no actions most of the time) needs to wake up to receive paging (in case of DL traffic arrival).

Therefore, in order to at least one of maximize power saving and save eNB's PUCCH resource, according to some embodiments of the invention the SR resource is linked to paging. If the SR periodicity is linked to the paging occasion as according to some embodiments of the invention, it may be a few seconds or even more.

In some embodiments, the agility for MTC UE to send UL data request is sacrificed, but since MTC UE traffic is delay tolerant, this is normally considered acceptable. If the time for paging (for DL traffic arrival) and time for SR (for UL traffic arrival) is made close to each other according to some embodiments of the invention, static MTC UE will enjoy maximized “sleeping time”, thus reducing power consumption. Also, SR resources for eNB's UL are saved. Considering large number of such MTC UE connected to a eNB, it's a lot of saving for eNB UL resource.

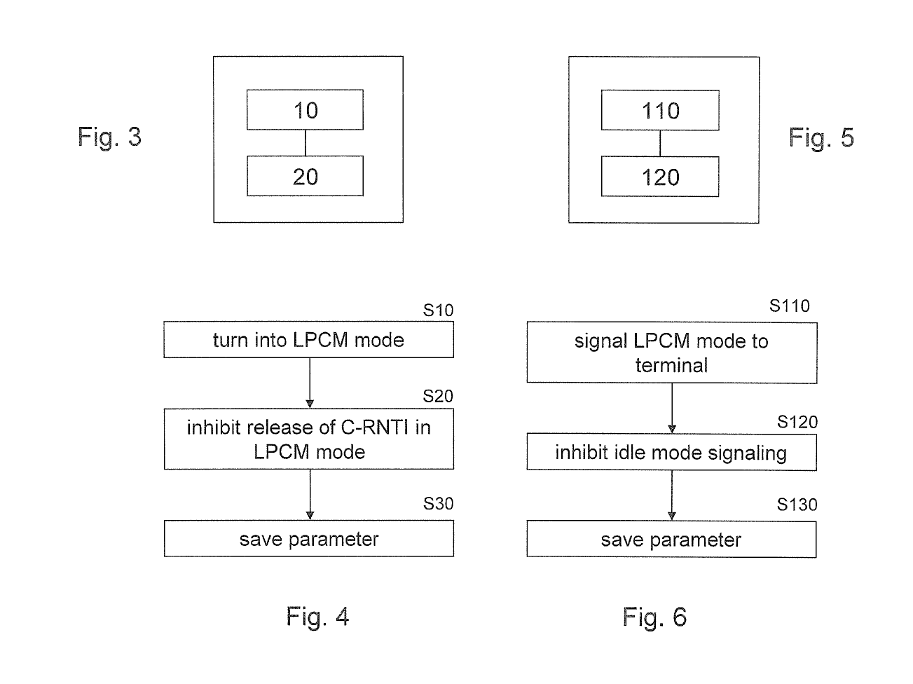

FIG. 3 shows an apparatus according to an embodiment of the invention. The apparatus may be a terminal such as a UE or a part thereof. FIG. 4 shows a method according to an embodiment of the invention. The apparatus according to FIG. 3 may perform the method of FIG. 4 but is not limited to this method. The method of FIG. 4 may be performed by the apparatus of FIG. 3 but is not limited to being performed by this apparatus.

The apparatus comprises at least one processor 10 and at least one memory 20. The at least one memory 20 includes computer program code, and the at least one processor 10, with the at least one memory 20 and the computer program code is arranged to cause the apparatus to at least perform: turning (S10) the apparatus into a low power connected mode upon receiving of a corresponding signaling from the base station device dedicated to the apparatus. In the low power connected mode, the processor inhibits (S20) releasing of a cell radio network temporary identifier. It saves (S30) parameters such as a radio bearer identifier, a ciphering key, a packet data convergence protocol, an internet protocol connection parameter, and a temporary mobile subscriber identity. These parameters were used by the apparatus for connecting with the base station device in the connected mode before it turned into the Low power connected mode.

FIG. 5 shows an apparatus according to an embodiment of the invention. The apparatus may be a base station such as a eNB or a part thereof. FIG. 6 shows a method according to an embodiment of the invention. The apparatus according to FIG. 5 may perform the method of FIG. 6 but is not limited to this method. The method of FIG. 6 may be performed by the apparatus of FIG. 5 but is not limited to being performed by this apparatus.

The apparatus comprises at least one processor 110 and at least one memory 120. The at least one memory 120 includes computer program code, and the at least one processor 110, with the at least one memory 120 and the computer program code is arranged to cause the apparatus to at least perform: signaling (S110), to a terminal device, to turn into a low power connected mode. This signaling may be performed upon receiving a report on a static type of the terminal device. If it was signaled to the terminal device to turn into the low power connected mode, signaling to the terminal device to turn into an idle mode is inhibited (S120). Parameters such as a cell radio network temporary identifier, a radio bearer identifier, a ciphering key, a packet data convergence protocol, an internet protocol connection parameter, and a temporary mobile subscriber identity used to connect with the terminal device in a normal connected mode before signaling to turn into the low power connected mode are saved (S130).

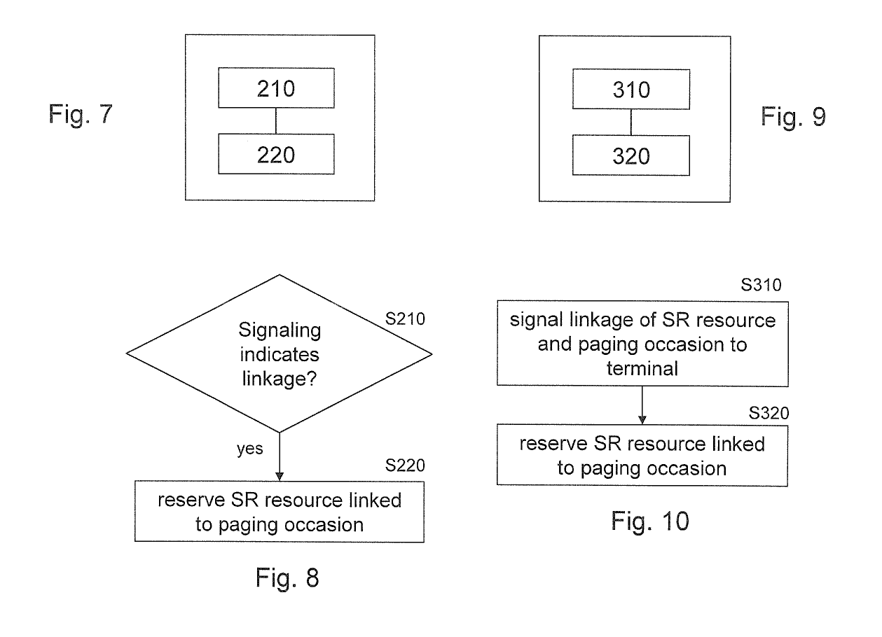

FIG. 7 shows an apparatus according to an embodiment of the invention. The apparatus may be a terminal such as a UE or a part thereof. FIG. 8 shows a method according to an embodiment of the invention. The apparatus according to FIG. 7 may perform the method of FIG. 8 but is not limited to this method. The method of FIG. 8 may be performed by the apparatus of FIG. 7 but is not limited to being performed by this apparatus.

The apparatus comprises at least one processor 210 and at least one memory 220. The at least one memory 220 includes computer program code, and the at least one processor 210, with the at least one memory 220 and the computer program code is arranged to cause the apparatus to at least perform: evaluating (S210) if a received signaling indicates a linkage of a scheduling request resource and a paging occurrence such that all occurrences of the scheduling request resource are injectively mapped to occurrences of the paging occasion. If such a linkage is indicated, the scheduling request resource is reserved according to the linkage (S220).

FIG. 9 shows an apparatus according to an embodiment of the invention. The apparatus may be a base station such as a eNB or a part thereof. FIG. 10 shows a method according to an embodiment of the invention. The apparatus according to FIG. 9 may perform the method of FIG. 10 but is not limited to this method. The method of FIG. 10 may be performed by the apparatus of FIG. 9 but is not limited to being performed by this apparatus.

The apparatus comprises at least one processor 310 and at least one memory 320. The at least one memory 320 includes computer program code, and the at least one processor 310, with the at least one memory 320 and the computer program code is arranged to cause the apparatus to at least perform: signaling (S310), to a terminal device, to reserve a scheduling request resource such that all occurrences of the scheduling request resource are injectively mapped to occurrences of a paging occasion. Then, after the signaling, the scheduling request resource is reserved for the terminal (S320).

Note that the normal connected mode is different from the low power connected mode as described hereinabove.

In contrast to US 2011/269447, in the LPCM some actions like measurements and mobility may be totally enabled/disabled for a period, and this is independently controlled by RRC signaling. Therefore, a better power saving than in the prior art may be achieved. Furthermore, by independent feature configuration, different tradeoff level of power saving and agility to traffic are enabled. Besides, RLM and L1 measurement are not considered to be disabled or reduced at all in prior art. Thus, the power saving may be even better than in idle mode.

Some embodiments of the invention are described with respect to MTC UEs. However, some embodiments of the invention may be employed in other devices, too, in particular if these devices indicate that they are static and/or delay tolerant.

A device may be a machine type device, a user equipment, a terminal, a mobile phone, a laptop, a smartphone, a tablet PC, or any other device that may attach to the mobile network. A base station may be a NodeB, an eNodeB or any other network element such as a base station of a radio network.

Some embodiments of the invention are described based on an LTE-A system but some embodiments of the invention may be applied to other radio access technologies such as LTE, WiFi, WLAN, UMTS, HSPA, if a connected mode is foreseen.

If not otherwise stated or otherwise made clear from the context, the statement that two entities are different means that they are differently addressed in their respective network. It does not necessarily mean that they are based on different hardware. That is, each of the entities described in the present description may be based on a different hardware, or some or all of the entities may be based on the same hardware.

According to the above description, it should thus be apparent that exemplary embodiments of the present invention provide, for example a controller apparatus such as a user equipment, a UE, or a component thereof, an apparatus embodying the same, a method for controlling and/or operating the same, and computer program(s) controlling and/or operating the same as well as mediums carrying such computer program(s) and forming computer program product(s). Furthermore, it should thus be apparent that exemplary embodiments of the present invention provide, for example a base station apparatus such as a NodeB or an eNodeB, or a component thereof, an apparatus embodying the same, a method for controlling and/or operating the same, and computer program(s) controlling and/or operating the same as well as mediums carrying such computer program(s) and forming computer program product(s).

According to exemplarily embodiments of the present invention, a system may comprise any conceivable combination of the thus depicted devices/apparatuses and other network elements, which are configured to cooperate with any one of them.

In general, it is to be noted that respective functional blocks or elements according to above-described aspects can be implemented by any known means, either in hardware and/or software/firmware, respectively, if it is only adapted to perform the described functions of the respective parts. The mentioned method steps can be realized in individual functional blocks or by individual devices, or one or more of the method steps can be realized in a single functional block or by a single device.

Generally, any structural means such as a processor or other circuitry may refer to one or more of the following: (a) hardware-only circuit implementations (such as implementations in only analog and/or digital circuitry) and (b) combinations of circuits and software (and/or firmware), such as (as applicable): (i) a combination of processor(s) or (ii) portions of processor(s)/software (including digital signal processor(s)), software, and memory(ies) that work together to cause an apparatus, such as a mobile phone or server, to perform various functions) and (c) circuits, such as a microprocessor(s) or a portion of a microprocessor(s), that require software or firmware for operation, even if the software or firmware is not physically present. Also, it may also cover an implementation of merely a processor (or multiple processors) or portion of a processor and its (or their) accompanying software and/or firmware, any integrated circuit, or the like.

Generally, any procedural step or functionality is suitable to be implemented as software/firmware or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

It is to be understood that what is described above is what is presently considered as some embodiments of the present invention. However, it should be noted that the description of the some embodiments is given by way of example only and that various modifications may be made without departing from the scope of the invention as defined by the appended claims.

1. An apparatus, comprising
at least one processor,
at least one memory including computer program code, and
the at least one processor, with the at least one memory and the computer program code, being arranged to cause the apparatus to at least perform:
turning the apparatus into a low power connected mode upon receiving of a corresponding signaling from a base station device;
inhibiting releasing of a cell radio network temporary identifier if the apparatus is in the low power connected mode;
saving a parameter used to connect to the base station device in a normal connected mode different from the low power connected mode before turning into the low power connected mode.

2. The apparatus according to claim 1, wherein the at least one processor is additionally arranged to perform:
disabling, if the apparatus is in the low power connected mode, at least one of a radio resource management measurement, a radio link measurement, a level 1 measurement, and a mobility function.

3. The apparatus according to claim 2, wherein the disabling of the at least one of the radio resource management measurement, the radio link measurement, the level 1 measurement, and the mobility function is performed upon receiving a corresponding signaling from the base station device dedicated to the apparatus, and/or based on a corresponding signaling from the base station to an indefinite number of terminal devices including the apparatus.

4. The apparatus according to claim 1, wherein the processor is additionally arranged to perform:
turning the apparatus from the low power connected mode into the normal connected mode upon receiving a corresponding signaling from the base station device; and
connecting, to the base station device, in the normal connected mode using the parameter.

5. The apparatus according to claim 1 to 4, wherein the parameter comprises at least one of a cell radio network temporary identifier, a radio bearer identifier, a ciphering key, a packet data convergence protocol, an internet protocol connection parameter, and a temporary mobile subscriber identity.

6. The apparatus according to claim 1 to 5, wherein the processor is additionally arranged to perform:
reporting on a static type to the base station device.

7. The apparatus according to claim 1 to 6, wherein the at least one processor is additionally arranged to perform:
reserving a first scheduling request resource with a first periodicity if the apparatus is not in the low power connected mode; and
reserving a second scheduling request resource with a second periodicity if the apparatus is in the low power connected mode; wherein
the first periodicity is shorter than the second periodicity.

8. The apparatus according to claim 7, wherein the second periodicity of the second scheduling request resource is linked to a third periodicity of a paging occasion of the apparatus such that all occurrences of the scheduling request resource are injectively mapped to occurrences of the paging occasion.

9. The apparatus according to claim 8, wherein each occurrence of the second scheduling request resource is shifted in time by a fixed offset relative to a corresponding occurrence of the paging occasion.

10. The apparatus according to claim 8, wherein each occurrence of the second scheduling request resource is bijectively mapped to every n^{th} occurrence of the paging occasion, wherein n is an integer equal to or larger than 1.

11. An apparatus, comprising
at least one processor,
at least one memory including computer program code, and
the at least one processor, with the at least one memory and the computer program code, being arranged to cause the apparatus to at least perform:
evaluating if a received signaling indicates a linkage of a scheduling request resource and a paging occurrence such that all occurrences of the scheduling request resource are injectively mapped to occurrences of the paging occasion;
reserving, if the evaluation is affirmative, the scheduling request resource according to the linkage.

12. The apparatus according to claim 11, wherein each occurrence of the scheduling request resource is shifted in time by a fixed offset relative to a corresponding occurrence of the paging occasion.

13. The apparatus according to claim 10, wherein each occurrence of the scheduling request resource is bijectively mapped to every n^{th} occurrence of the paging occasion, wherein n is an integer equal to or larger than 1.

14. The apparatus according to claim 1, wherein the apparatus further comprises a user equipment, and
at least one radio interface configured for communication with at least the base station device.

15. An apparatus, comprising
at least one processor,
at least one memory including computer program code, and
the at least one processor, with the at least one memory and the computer program code, being arranged to cause the apparatus to at least perform:
signaling, to a terminal device, to turn into a low power connected mode;
inhibiting signaling, to the terminal device, to turn into an idle mode;
saving a parameter used to connect to the terminal device in a normal connected mode different from the low power connected mode before signaling to turn into the low power connected mode.

16. The apparatus according to claim 15, wherein the at least one processor is additionally arranged to perform, if it signals to the terminal device to turn into the low power connected mode:
inhibiting supervising a receipt of at least one of a radio resource management measurement result, a radio link measurement result, a level 1 measurement result, and a result of a mobility function from the terminal device.

17. The apparatus according to claim 16, wherein the at least one processor is additionally arranged to perform:
signaling, if the apparatus signals to the terminal device to turn into the low power connected mode, to the terminal device to disable the at least one of the radio resource management measurement, the radio link measurement, the level 1 measurement, and the mobility function by the terminal device, and/or
signaling to an indefinite number of terminal devices including the terminal device to disable, if the respective terminal device turns into the low power connected mode, the at least one of the radio resource management measurement, the radio link measurement, the level 1 measurement, and the mobility function by the respective terminal device.

18. The apparatus according to claim 15, wherein the at least one processor is additionally arranged to perform:
signaling to the terminal device to turn from the low power connected mode into the normal connected mode; and
connecting, to the terminal device, in the normal connected mode using the parameter.

19. The apparatus according to claim 15, wherein the parameter comprises at least one of a cell radio network temporary identifier, a radio bearer identifier, a ciphering key, a packet data convergence protocol, an internet protocol connection parameter, and a temporary mobile subscriber identity.

20. The apparatus according to claim 15, wherein
the signaling to turn into the low power connected mode is performed upon receiving a report on a static type of the terminal device.

21.-56. (canceled)
